(19) United States
(12) Patent Application Publication
(10) Pub. No.: US 2014/0326591 A1
(43) Pub. Date: Nov. 6, 2014

(54) Vapor Absorption System

(71) Applicant: Abaridy Pty Ltd., Western Australia (AU)

(72) Inventors: Jayden David Harman, San Rafael, CA (US); Bruce Webster, Northville, MI (US); Kasra Farsad, San Jose, CA (US)

(73) Assignee: Abaridy Pty Ltd., Western Australia (AU)

(21) Appl. No.: 13/887,281

(22) Filed: May 4, 2013

(51) Int. Cl. B01D 3/10

(52) U.S. Cl. CPC B01D 3/106
USPC 202/184

(57) ABSTRACT

A vapor absorption system adapted to receive a vapor comprising a vacuum pump having an operating liquid wherein the vapor is received by an operating liquid and condensed therein to provide condensed liquid mixed with the operating liquid.

### BACKGROUND OF THE INVENTION

1. Field of the Invention

The present invention generally relates to absorption of a vapor into a liquid. More specifically, the present invention relates to distillation of a liquid mixture such as water with impurities or application as a heat transfer system.

2. Description of the Related Art

Absorption, in chemistry, is a physical or chemical phenomenon or a process in which atoms, molecules, or ions enter some bulk phase by being taken up by the volume. The present application primarily concerns the absorption of a vapor into a liquid.

Usual vapor absorption techniques have specific application. They are usually relatively slow process unless some chemical reaction is occurring. Because of this, absorption processes have relatively limited application.

Distillation is a well-known process. It is used often where traditional filtration techniques have not been effective at purifying a liquid mixture. Conventional distillation requires the application of heat energy to cause the production of a vapor, which is then passed through a condenser to condense the vapor back to a liquid for use. While conventional distillation is generally effective at purifying liquids such as water, the energy cost is substantial and often uneconomic. Improvements to the process have increased efficiency, but the process has remained too expensive for purification of water for general use.

Efforts to improve the efficiency of the distillation process have included attempts at operation at reduced pressure. It is well known that vaporization of liquid occurs more rapidly when the pressure is reduced. However, such systems have had limited success due to difficulty and expense associated with an evacuating system in conjunction with the evaporation and condensing subsystems. For example, some prior art systems utilizes the low pressure region of a venturi to provide the reduced pressure.

Heat transfer systems are also well known. Air-conditioning and refrigeration systems form subsets of this broad category. It is well known that conventional heat exchange systems use very substantial amounts of energy in order to transfer energy.

There is a need in the art for improved distillation and heat transfer systems that make use of vapor absorption. There is a particular need £or obtaining a faster rate of absorption where chemical interaction is not involved. Through such a system, the efficiency or C.O.P. (co-efficient of performance) of a heat transfer system may be improved.

### SUMMARY OF THE PRESENTLY CLAIMED INVENTION

In a first claimed embodiment of the present invention, a vapor absorption system is disclosed. The system includes an evacuation chamber that receives a secondary liquid and a vacuum pump that operative causes gas pressure within the evacuation chamber to be reduced thereby promoting the vaporization of vapor from the secondary liquid. In this embodiment, a primary liquid passes through the vacuum pump, wherein the vacuum pump allows the primary liquid to receive vapor vaporized from the secondary liquid and to cause the vapor to condense within the primary liquid. The result is a condensed liquid mixed with the primary liquid whereby the absorption of vapor within the system is effective to cause production of more vapor.

### BRIEF DESCRIPTION OF THE DRAWINGS

FIG. 1 illustrates is an embodiment of a distillation system;

FIG. 2 illustrates a further embodiment of a distillation system;

FIGS. 3-5 illustrates still further embodiments of a distillation system;

FIG. 6 illustrates a hear exchange system.

FIG. 7 illustrates an embodiment of a vapor absorption system.

### DETAILED DESCRIPTION

The vapor absorption systems disclosed herein place a vapor under a vacuum by use of a vacuum pump having an operating liquid wherein the vapor is received by the operating liquid and condensed therein to provide condensed liquid mixed with the operating liquid. The system therefore is limited to a system whereby the vapor condenses when being absorbed by the operating liquid, rather than an alternative such as being dissolved as a gas. The system is particularly applicable where the system is incorporated in a continuous process and in particular where the absorption of vapor is operative to cause the production of new vapor.

The system is most easily provided by use of a venturi vacuum pump and the operating liquid is the liquid which passes through the venturi to produce a vacuum. The venturi thereby produces a vacuum which draws the vapor into the operating liquid, where it condenses.

Typical vapors may be water vapor, or methanol. Many others are suitable. In some instances the operating liquid is of the same substance as the vapor. Distillations systems are described below where the operating liquid is water and the vapor is water vapor. In other instances, the operating liquid and the vapor may be different substances.

One embodiment described uses oil as the operating liquid and water as the vapor, while another uses water as the operating liquid and methanol as the vapor. Ongoing vaporization can occur as part of a continuous process. Indeed, the use of the vacuum pump enables the vapor to be replenished because the vapor pressure is reduced as the vapor is absorbed.

For a distillation system, the distilled product may be withdrawn from the system for use. In contrast, a heat transfer system is a dosed system and nothing (or almost nothing) need be withdrawn or added. Generally, the system will operate on a recycling basis, where the operating liquid recycles through the system. But there are configurations where that need not be the case.

The vapor absorption system may utilize a vacuum pump of high efficiency. Said pump may be a venturi vacuum pump like that disclosed in co-pending patent application number ______filed ______, 20______ and incorporated herein by reference.

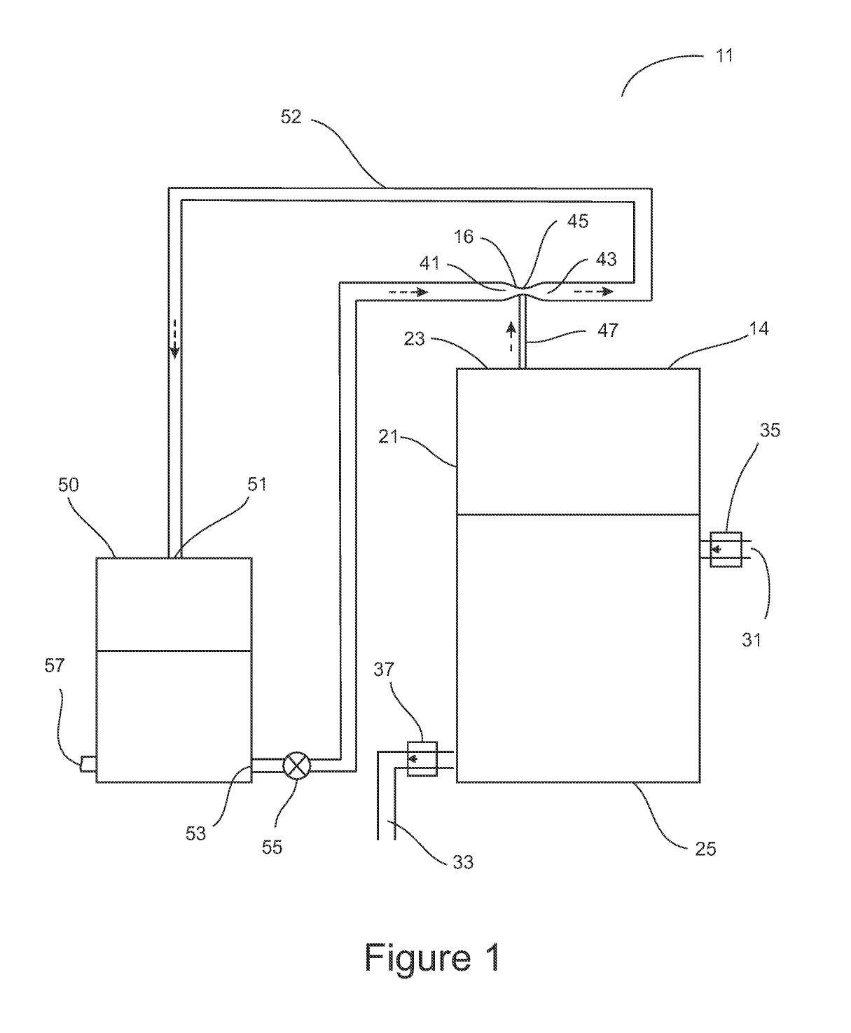

The first embodiment of the invention is directed to a distillation system which incorporates an evacuation chamber and an evacuation pump. The embodiment is described with reference to FIG. 1.

The distillation system 11 according to the first embodiment comprises an evacuation chamber 14 adapted to receive a quantity of liquid to be distilled. For the purposes of this description, the embodiment will be described with reference to the distillation of water, referred to herein as secondary water, such as contaminated water or ground water which is too polluted or mineralized for direct use, but reference will be made later in the description to the distillation of other mixtures including liquid mixtures.

The evacuation chamber 14 is adapted to be evacuated to a reasonably high level (preferably less than 3 kPa) by one or more evacuation pumps 16 and therefore is constructed accordingly. The actual design of the evacuation will depend upon the circumstances of the installation. Those skilled in the art will be able to identify the appropriate design criteria. Typically, an evacuation chamber may comprise a substantially cylindrical vessel with the axis of the cylinder 21 being oriented substantially vertically. The ends 23, 25 may be strengthened by being of convex or concave profile. But other configurations such as substantially spherical chambers are conceivable.

The evacuation chamber 14 is provided with an inlet 31 and a drain or outlet 33. In the first embodiment, a first valve 35 is associated with the inlet 31 to allow secondary water to enter the chamber upon demand. A second valve 37 is associated with the drain 33 to enable concentrated solution to be flushed from the chamber 14 at the end of a batch process. The evacuation chamber 14 is also provided with access means to enable maintenance of the interior of the chamber 14. The access means may be provided by a removable panel (not shown) or by removal of one of the ends 23 or 25. This access may be used to remove scale and other solid material which may be deposited from the secondary water.

The evacuation pump 16 is arranged to extract vapor from the upper portion of the chamber 14. In the first embodiment the evacuation pump 16 is a venturi pump, and as is discussed below, a venturi pump is particularly suitable for use in relation to the invention. The venturi pump 16 comprises a venturi inlet 41, a venturi outlet 43 and a narrowed venturi throat section 45 intermediate the venturi inlet 41 and the venturi outlet 43. In the first embodiment a port 47 connects the low pressure venturi throat section 45 of the venturi pump 16 with the evacuation chamber 14.

In operation, the venturi pump 16 evacuates the evacuation chamber to a pressure below that of the vapor pressure of the secondary water in the evacuation chamber 14. As a result the secondary water is caused to boil at a relatively low temperature that can be close to normal room temperature.

The venturi pump is typically connected to a tap or valve of the mains water supply and the water passing through the venturi pump causing the reduced pressure is disposed to waste. The water being expelled from the venturi pump comprises not just the water that enters the venturi inlet 41 but also water from the vapor that is withdrawn from the evacuation tank through the port 47. Such vapor condenses almost immediately upon entering the water stream flowing through the venturi throat section 45.

The first embodiment is therefore provided with a receiving tank 50 having a tank inlet 51 connected by piping 52 to the venturi outlet 43. A recirculation outlet 53 is provided proximate the base of the receiving tank 50 which supplies primary water (purified water) to a recirculation pump 55 which pumps primary water to the venturi pump 16. The recirculation pump 55 is selected to be of the size and type suitable to feed the venturi pump 40 at the required pressure and flow rate.

A water take off port 57 is provided either as a separate outlet from the receiving tank 50 or as a port from the piping 52 or otherwise to withdraw water from the receiving tank 50 for use. The rate of withdrawal is controlled to prevent the receiving tank from being emptied. To this extent, the receiving tank can act as well as a storage tank or alternatively storage means may be provided separately.

In operation, it can be seen that water is pumped from the receiving tank 50 by the recirculation pump 55 to the venturi pump 16 and then returned to the receiving tank 50. In the process, water is received into the stream from the water vapor extracted from the evacuation tank 14. As is discussed below, it is possible to achieve a take-up rate of about 1 part of water from the evacuation tank to approximately 30 parts of water pumped through the venturi pump 16. The system can therefore be sized according to the volume of water to be withdrawn from the receiving tank 50.

An apparatus according to the first embodiment has removed the need for a conventional condenser system within the distillation system. Condensation takes place inherently in the venturi pump 16.

While the distillation system described does not require the secondary water to be raised to a high temperature, it is to be appreciated that the boiling process nonetheless requires the input of heat energy to provide the latent heat of vaporization. The advantage of the system is that while the energy must be provided, because the evaporation system can be arranged to operate at or near an ambient or normal temperature, a low grade heat source may be used.

For small units, the evacuation tank 14 may be configured to withdraw sufficient energy from the atmosphere. In the first embodiment, the cylindrical wall of the evacuation chamber 14 has a corrugated profile to increase the surface area and thereby facilitate the removal of heat from the atmosphere. In a further adaptation, the external surface of the evacuation chamber is painted black to promote the absorption of heat from the external environment.

The temperature required in the secondary water depends significantly upon the performance of the vacuum pump and in particular the vacuum level achieved. At the same time, it is to be appreciated that as the pressure, is reduced a greater volume of vapor will be caused to boil off. A significant difference between the temperature of primary water and the secondary water may be desirable. The primary water should be at least 15° C. cooler than the secondary water. Preferably, the primary water should be cooler than the secondary water by 20° C. or more.

It is desirable that the temperature of the secondary water is in the vicinity of at least 40° C. or more and therefore, this embodiment can be suitable for a situation where the surroundings can provide the latent heat energy from the surroundings.

In some locations, secondary water is available that is already at or above the desired operating temperature of the secondary water. In these circumstances, the latent heat may be provided simply by having a controlled, continuous flow of secondary water through the evacuation chamber at a rate somewhat above the rate of evaporation of vapor. This arrangement has the added advantage that the level of concentration of the salts in the secondary chamber is kept at a stable level which is not substantially higher than that of the incoming secondary water. This may reduce the build up of salt deposits in the evacuation chamber and therefore reduce the maintenance requirements of the chamber.

For this latter reason, continuous flow of the secondary water will be preferred even where the secondary water is too cool and additional heating must be added, as in the second embodiment. In one variation, a feedback control system is incorporated to regulate the flow of secondary water through the evacuation chamber to control the temperature and/or the salt concentration to desired levels.

It will also be appreciated that the latent heat energy contained within the water vapor will be added to the water flowing through the venturi pump 16 at the time the water vapor condenses into the flow stream. As discussed below, the temperature of the primary water flowing into the venturi may be significantly below that of the secondary water, and in the embodiment, the temperature is kept around 12° C.

In the first embodiment, this heat energy is transferred to the receiving tank where it is dispersed to the environment, If the receiving tank also serves as a storage tank with a relatively large volume, the temperature rise will be minor and easily dispersed. There are many locations where this means of disposing of the heat will be suitable. In other locations, it is practicable to disperse the heat into the ground by passing outlet pipes through the ground before the water is passed to storage. Other means of cooling will be apparent to those skilled in the art where appropriate circumstances apply.

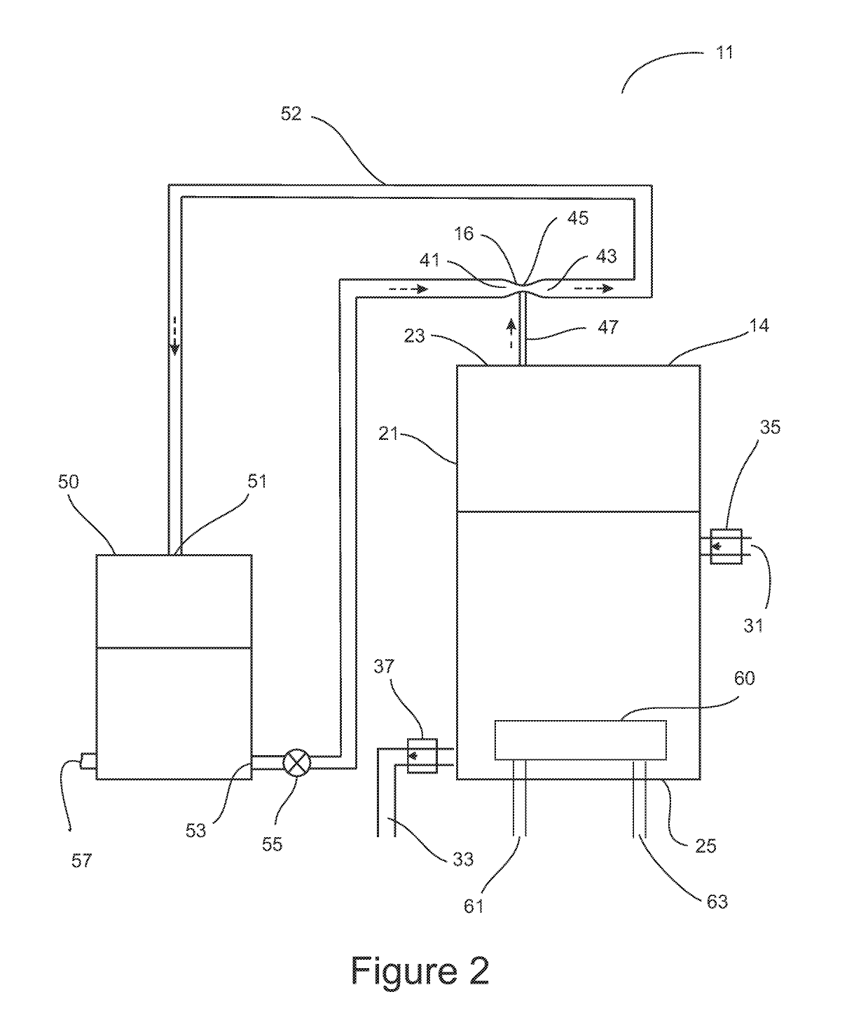

A second embodiment takes cognizance of the energy flow that is required and is adapted to facilitate those flows. The second embodiment is described with reference to FIG. 2. The second embodiment is similar to the first embodiment, and therefore, in the drawings, like features are denoted with like numerals.

The second embodiment differs from the first embodiment by the inclusion of a evaporation heat exchanger 60 positioned to be within the secondary water in the evaporation chamber 14, or otherwise associated with the evaporation chamber 14 to allow heat flow from the evaporation heat exchanger 60 to the secondary water. The evaporation heat exchanger 60 is provided with an exchanger inlet 61 and an exchanger outlet 63. The exchanger inlet 61 is supplied with exchanger fluid from a low grade heat source. Examples of suitable heat sources are a solar heated pond, or water heated from a geothermal source.

The exchanger fluid exits through the exchanger outlet 63 and returned to the heat source for reheating. The rate of flow may be maintained to control the heat input to the secondary water, or alternatively, the heat input to the exchange fluid may be controlled at the heat source. It is to be appreciated that the effectiveness of the distillation system according to the embodiments depends upon the effectiveness of the venturi in reducing pressure and drawing vapor away.

Certain embodiments of an improved venturi comprise a chamber having an inlet tube, an outlet tube and a vacuum port. Such units therefore can be readily used in the first and second embodiments. Other embodiments of the improved venturi do not have a chamber and draw the gas or vapor directly from its surroundings.

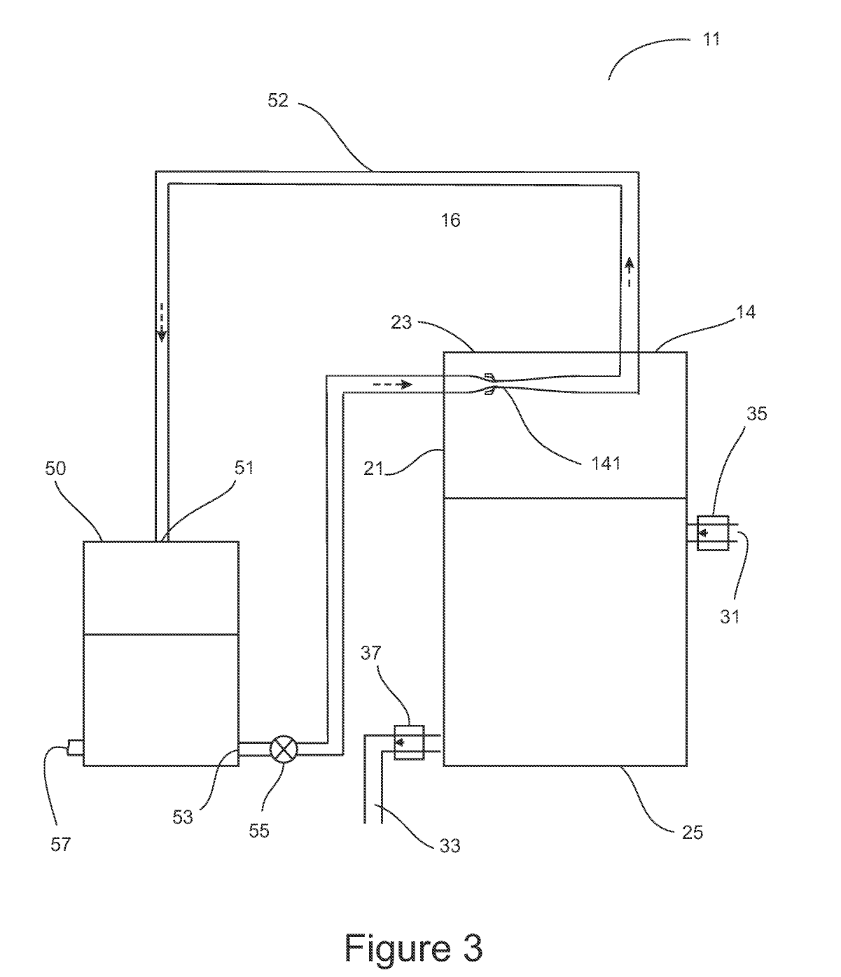

Therefore a third embodiment of a distillation system is disclosed which is adapted to incorporate a venturi as described. The third embodiment is described with reference to FIG. 3. The third embodiment is similar to the first embodiment and so, in the drawings, like numerals are used to denote like features.

The difference between the third embodiment and the first embodiment is that the venturi is placed inside the evacuation chamber 14 proximate the upper end 23, rather than being outside the evacuation chamber 14 and connected to the evacuation chamber by port 47.

In a variation of the third embodiment, a filtration means is provided at the vapor entry into the venturi to remove any liquid droplets and return them to the secondary water, thereby avoiding contamination of the primary water. This water is not returned to the venturi and therefore the heat rise due to release of latent heat upon the absorption and condensation of the vapor does not affect the operation of the distillation system.

It is possible to operate a plurality of venturis in parallel to remove a higher volume of vapor. Embodiments of the invention are scalable from small domestic units to large systems suitable for reticulated supplies of cities.

In an adaptation of the first, second or third embodiments, where a continuous stream of cold water is available, this stream can be fed directly to the venturi as the primary water. This may be the case for a supply of water for a town or city. Water being supplied to consumers may be broken into several smaller streams and passed through a plurality of venturi vacuum pumps associated with one or more evacuation chambers. While the condensation/absorption process will heat the water as discussed, this will not usually be a problem, particularly in cold environments where it may even be an advantage.

In such installations the water is often gravity fed, which removes the need for a pump to pressurize the primary water entering the venturi. If a low cost energy source is available to provide the latent heat, the operating cost will be very low. Without recirculation, the amount of water collected will only be small, around 5% to 8% of the primary water presented.

The productivity may be increased by introducing some recirculation. This could be achieved by having a holding pond above the elevation of the distillation system from which the primary water is supplied and a certain proportion of the flow can be pumped into the holding pond. This would allow a water authority considerable flexibility. When rain water is plentiful, no recirculation is required and a percentage increase in supply is provided at minimal operating cost. When supply is moderate, still adequate but less than needed to keep the storage systems full, some recirculation can be provided to maintain the storage system dose to capacity. As rainfall supply becomes low, so the storage supply is being drained, recirculation can be increased to a more significant level to slow the fall of storage levels but not to stop it. If a drought occurs and storage levels become critical, recirculation can be increased so that the distillation system provides almost the full demand. Even where low-grade energy is only available to a limited extent, the distillation cost will still be competitive with alternative drought relief measures.

It is worth noting that in many places, times of drought risk coincide with time of high solar energy availability (summer), so with an appropriate designed solar energy system, modest energy cost will be available. In a normal year, additional costs for pumping may be easily amortized and offset against the times no pumping is required to maintain a very economic water supply.

It can be seen that a distillation system according to the embodiments described so far wherein a vacuum pump reduces the pressure in an evacuation chamber causing secondary water therein to boil and wherein the water vapor resulting is received directly into primary water associated with the vacuum pump has advantages. Due to direct removal of the water vapor into primary water, no separate condensation unit is required. As well, the boiling occurs at a temperature that is considerably lower than at normal pressure, which means that the hazards are reduced significantly. Also, as previously discussed, the heat required can be provided from a low grade source at considerably reduced expense. Especially for larger installations, the capital cost as well as the maintenance and running costs will be considerably reduced over those of competing technologies.

While the application has been discussed with respect to water containing contaminants, pollution of dissolved salts, or to mixtures such as water and heavy metals or water and sewerage, the systems described can be readily adapted to a much wider range of mixtures including mixtures of liquids. its use for the distillation of ethanol from an ethanol water mixture is most advantageous.

Typically, when ethanol is obtained from crops such as tapioca or corn, the processing results in a liquid mixture that contains approximately 20% alcohol to 80% water. Conventionally, this mixture is distilled at high temperature in a process that requires considerable high grade energy and this affects the cost of production. However, use of the distillation process as described herein enables the high grade energy to be replaced by low grade energy.

In addition, the distillation process works in reverse from the normal distillation process described for sea water. Because the ethanol-water mixture is an azeotrope, the secondary mixture in the evacuation chamber which starts at about 20% alcohol will be concentrated by the distillation process towards the azeotropic concentration of approximately 96% ethanol. The evacuation boiling process results in a certain amount of the ethanol being evaporated as well as the water. This evaporated ethanol is taken up by the primary water in the venturi and therefore is not lost.

While the ethanol concentration in the primary water will be relatively low, the primary water can then be utilized at an earlier stage of the production process so that the ethanol will once again end up being distilled. Thus there is no loss of product but a substantial reduction in energy costs is achieved. Where, alcohol is required at a higher level of purity than the azeotropic concentration, existing production techniques can be used or adapted to raise the concentration further. It will be appreciated that there are many other distillation processes that can benefit from the application of the embodiments to those processes.

The process so far has been described with reference to distillation, but as mentioned before the vapor absorption process has an effect that has other applications. In order to provide a better understanding of the invention, a summary of the principles of operation are given below.

The salt water in the tank 14 is boiled off at extremely low pressure. The low pressure is generated via the venturi effect from the fresh water flow through the venturi 16. Pressures less than 3 kPa are desirable. This will allow the water to boil off at temperatures between 30-65° C.

As the water boils away from the salt water mixture energy must be added to the system. Note if water is vaporised at a rate of 1 ml/sec, 2.4 kW of power must be supplied to provide the latent heat. Any available heat source may be used but low cost power such as solar power or waste heat is preferred.

The process is aided by the low pressures generated by the fresh water flow because of the efficient design of the venturis used. The pressure within the evaporation tank 14 can reach below 3 kPa. In addition, the fresh water flow should be cool at approximately 10-20° C. Temperature differential may be useful in sustaining the boiling process. A temperature differential of at least 20° C. and preferably higher is desirable. If the temperature of the fresh water flow stream approaches the temperature of salt water in the tank, the fresh water flow cavitates, greatly reducing the efficiency of the cycle.

Fresh water vapor is entrained into the fresh water flow at the venturi. Since the fresh water flow is much colder than the water vapor, the water vapor immediately goes back into solution, releasing significant heat.

The fresh water stream at the outlet 43 is now significantly warmer than and must be cooled. This may be accomplished by any appropriate means available at the location, such as pumping the water underground.

Since the cycle boils the salt water at much lower temperature, a heat source of lower quality (temperature) may be used. It is believed that solar energy may be used in many locations to maintain the temperature of the salt water in the vicinity of 50° C.

Since we are using a lower quality heat source, the energy input into the system from man-made sources is greatly reduced, thereby increasing the efficiency of the system.

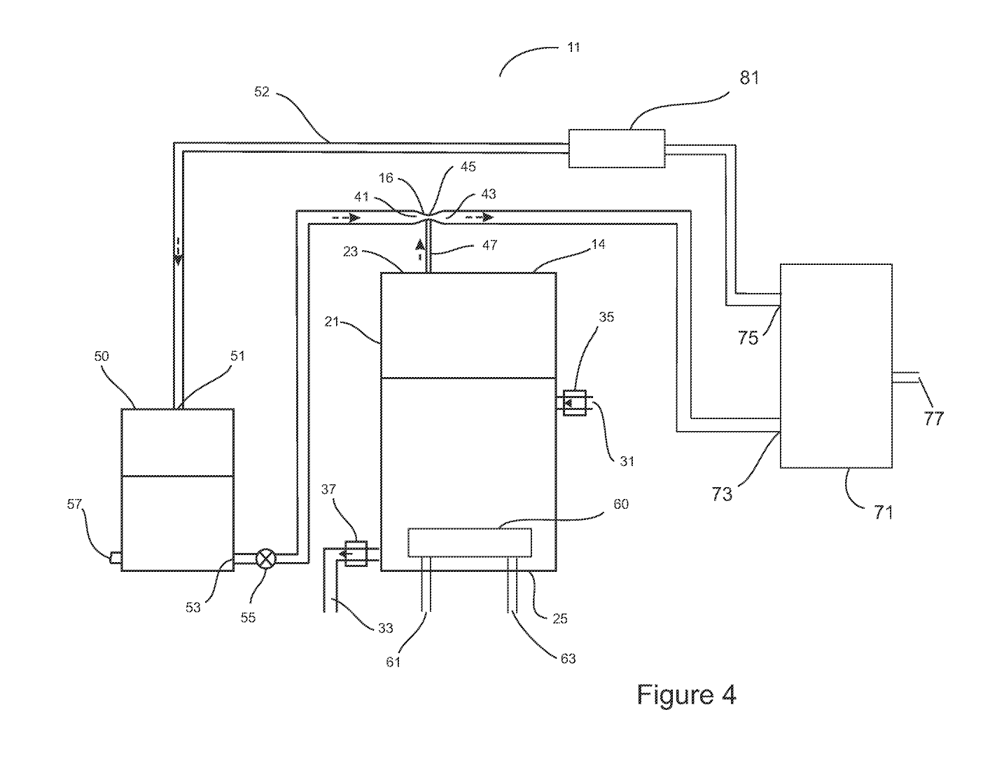

It has been found that the primary liquid can be vegetable or other oil or other immiscible chemicals or an oil-water mix. In this case the oil can be at ambient temperature and does not need to be cooled to a temperature below that of the sea water mixture in the evaporation chamber. Therefore, a fourth embodiment is described with reference to FIG. 4 which benefits from this advantage. The fourth embodiment is similar to the second embodiment and so, in the drawings like numerals are used to depict like features.

The significant difference between the fourth embodiment and previously described embodiments is that an oil is used as the primary liquid which is passed through the venturi vacuum pump 16 rather than water. As the oil travels through the venturi vacuum pump 16 it reduces pressure in the salt water mixture in the evaporation chamber 14, and causes the reservoir water to boil and vaporize in the manner as previously disclosed with reference to the first and second embodiments. Instead of being recycled directly, the resulting primary mixture of oil and condensed water is passed to a separator inlet 73 of separation means 71.

The separation means 71 may take the form of a settling tank or a cyclone or other device adapted to separate the secondary water and oil. The oil is removed from the settling means 71 at oil outlet 75 and recirculated while the distilled water is drawn off from water outlet 77. The primary mixture of oil and condensed water is still heated from the latent heat when the water condenses, but it is no longer essential to drop the temperature below that of the water mixture in the evacuation tank. Therefore a conventional heat exchanger 81 is provided which can remove the heat of the heated oil to ambient surroundings, lowering the temperature to only a little above ambient.

With oil, the venturi will still perform satisfactorily at this temperature. After leaving the heat exchanger 81 the oil is either returned to receiving tank 50 or indeed may be returned directly to the inlet of the venturi vacuum pump. If used, the receiving tank 50 may only be a holding tank with no cooling function at all, although in certain applications further cooling may still be desirable.

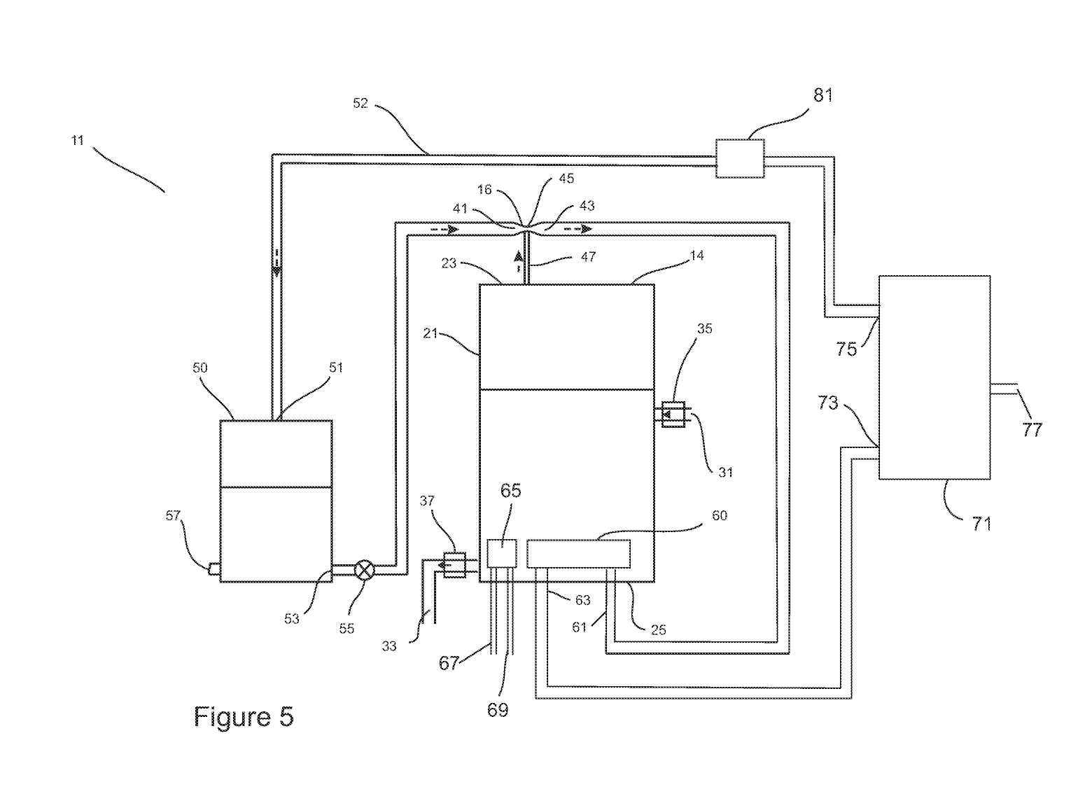

It can be seen that the use of oil or the like expands the applications of the invention. The use of oil or similar as the primary liquid as in the fourth embodiment allows a further adaptation which has a major impact of the viability of the distillation system of the invention for many applications. A fifth embodiment now describes that adaptation with reference to FIG. 5. The fifth embodiment is very similar to the fourth embodiment, and so, in the drawings, like numerals are used to depict like features.

The fifth embodiment differs from the fourth embodiment by routing the primary mixture of oil and condensed water which exits from the venturi vacuum pump 16 to the inlet 61 of the evaporation heat exchanger 60 associated with the evaporation chamber 14. When the fluid exits from the evaporation heat exchanger 60 at outlet 63 it passes to the separation means 71 where the water and oil are separated as in the fourth embodiment.

The advantage of the fifth embodiment is that a substantial portion of the latent heat required for vaporization in the evacuation chamber is supplied by the latent heat returned to the oil/water mixture when the water condenses. Fundamentally, the latent heat required for vaporization is equal to the latent heat returned to oil/water mixture when the vapor condenses. The effectiveness will depend upon the extent to which the latent heat can be extracted by the evaporation heat exchanger 60. With a high efficiency heat exchanger, a small temperature difference can sustain extraction of a substantial percentage of the latent heat.

It is not possible to extract all energy from the oil/water mixture and therefore a supplementary heat exchanger 65 having an inlet 67 and an outlet 69 is provided to receive energy from a suitable source to provide the additional energy nor taken from the evaporation heat exchanger. However, with appropriate selection of an oil and an appropriate design of the venturi vacuum pump the percentage of energy required to be provided by the secondary heat exchanger 65 will be relatively small so that the overall efficiency of the system is high. In operation, the equilibrium of the system can be controlled by the extent of energy input from the supplementary heat exchanger 65. This can be controlled by adjusting the temperature of the fluid passing through the supplementary heat exchanger 65 as well as the flow rate of that fluid.

Crucially, the effectiveness of system will depend upon the extent that the performance of the venturi will be maintained where the temperature of the primary liquid is above the temperature of the liquid being evaporated. With the first three embodiments, the performance deteriorates drastically so that operation of the system collapses. But as discussed, where oil is used the venturi performance continues. Choice of primary liquid will therefore be an important criteria when the system is used for the distillation of other liquids.

Up until this point of the description, a system has been described wherein a liquid is distilled by generating a substantial vacuum. ‘To support the process, except for the fifth embodiment, significant amounts of energy must be transferred into the liquid to be distilled in order to supply the latent heat of vaporization. Providing this heat at reasonable cost is a key factor to the commercial viability of the distillations systems that have been described.

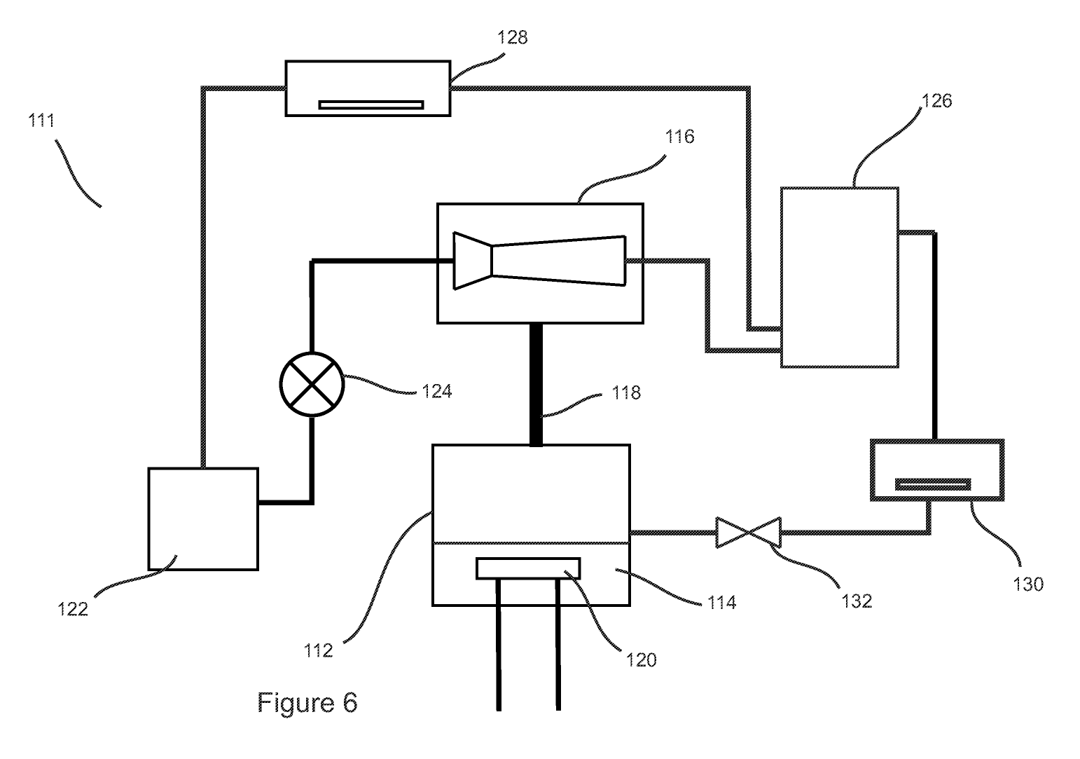

A sixth embodiment of the invention is also described. This system is used as a heat transfer system although it is an adaptation of the fourth embodiment. The embodiment of the heat transfer system is now described with reference to FIG. 6 and the distillation system of the second embodiment. As shown in FIG. 6, the heat transfer system 111 comprises an evacuation chamber 112 adapted to hold a body of a refrigerating liquid 114. One or more high performance venturi vacuum pumps 116 are associated with the chamber 112 by connection means 118 to reduce the pressure within the evacuation chamber 112 to cause boiling of the refrigerating liquid 114 and thereby vaporization.

The vapor derived is drawn off by the venturi vacuum pump through the connection means 118 in a manner similar to that of the embodiments of the distillation system previously described. As in the second embodiment of the distillation system, a first heat exchanger 120 is associated with the evacuation chamber 112 to provide relatively warm fluid to the heat exchanger 120 to supply the heat which is surrendered to the refrigerating liquid 114 to provide the latent heat of vaporization. In the process, the heat exchange fluid is cooled and this cooled fluid can be circulated to a remote heat exchanger, for air conditioning, refrigeration or the like.

While the principle of operation is the same as for the distillation system, certain details differ because the object is not to draw off a purified liquid but to transfer heat. The system is therefore configured to recycle the liquid that is evaporated back to the evaporation chamber. The liquid in the evaporation chamber is therefore a refrigerant and certain co-fluids have been found to be particularly suitable, amongst them acetone/water, methanol/water and linoleic add/methanol.

For the remainder of the discussion of this embodiment, the use of water/methanol will be discussed. In that case, the refrigerating liquid is methanol and the primary liquid is water. Optionally, a supply of water is stored in container 122. Water from the container 122 is pumped by pump 124 at a relatively low pressure in the order of 200 kPa to the venturi vacuum pump 116. The reduced pressure generated by the venturi as the primary water flows through it causes methanol in the evaporation container to boil and the vapor to be conveyed to the venturi where it is absorbed into the primary water and condenses to liquid almost instantaneously. Again latent heat is released into the water/methanol mixture causing the temperature of the mixture to rise. The water/methanol mixture exits the venturi and is conveyed to a separating means 126.

At the separating means 126, the methanol is separated from the water and then drawn off. At this time, the water and methanol are at raised temperature. After being removed from the separating means 126, water is passed to a primary loop heat exchanger 128 to release heat to the environment. As the temperature of the water does not need to be reduced below ambient, a simple heat exchanger will suffice. As well, the methanol is heated and preferably this also passes through a methanol heat exchanger 130 before being returned to the evaporation chamber 112.

As an alternative to the provision of a primary loop heat exchanger and a methanol heat exchanger, a single heat exchanger may be provided before the separating means to cool the water/methanol mixture. While this arrangement is preferable because of the use of a single heat exchanger, it may introduce problems with certain fluid mixtures. In either caser there will be applications where the heat energy is used for heating purposes by appropriate use of the heat exchanger. A valve means 132 between the methanol heat exchanger and the evaporation chamber 112 (or separating means 126 and evaporation chamber 112 if there is no methanol heat exchanger) controls the return of methanol to the evaporation chamber 112.

In certain adaptations, a primary liquid and secondary liquid are of the same substance and evacuation chamber and venturi vacuum pump form a closed system. A heat transfer system comprising an evacuation chamber adapted to receive a first liquid, at least one venturi vacuum pump associated with the evacuation chamber to cause, in use, the pressure within the evacuation chamber to be reduced to promote vaporization of liquid in the chamber, and a first heat exchanger having a fluid pathway for a heat exchange fluid to pass through the first heat exchanger and being associated with the evacuation chamber to provide heat to the first liquid in the chamber to support the vaporization and thereby to cool the heat exchange fluid.

Physically, the amount of vapor processed is limited firstly by the amount of energy that is available for vaporization of the secondary liquid. This limitation becomes particularly important where the quantity of vapor being processed is relatively large. The availability of the heat energy and the means for transferring it to the secondary liquid then become vital design consideration of a vapor absorption system. It is noted that the amount of heat available depends both upon the capability of the heat source to provide the heat energy and also the capability to transfer this energy to the secondary liquid, that is, the capability of the heat exchanger.

It has been found that there is a difference between the ability of a venturi vacuum pump to process vapor and the maximum vacuum (minimum pressure) that it is capable of pulling. This is the aspect that has not been considered previously by the prior art Co-pending application number ______ entitled Vacuum Condenser and filed ______ describes a venturi vacuum pump which is optimized to absorb vapor for a preselected power input to produce a desired level of vapor absorption. Hereinafter, reference to a vacuum condenser denotes a venturi vacuum pump that adopts the principals of that disclosure to thereby provide a highly effective vacuum pump. This application is hereby incorporate by reference.

The most effective vacuum condenser will not necessarily pull the maximum vacuum. ‘The operational requirements are subtly different. Pulling the maximum vacuum requires that device continues to effectively scavenge gas molecules when the operational pressure becomes very low. In contrast, a vacuum condenser is concerned with absorbing the maximum volume of gas that it can do without concern for what the operational pressure happens to be. In doing so it sets up a flow of the vapor within the vacuum condenser and it is the cooperation between the vapor flow and the primary liquid flow that leads to effective absorption.

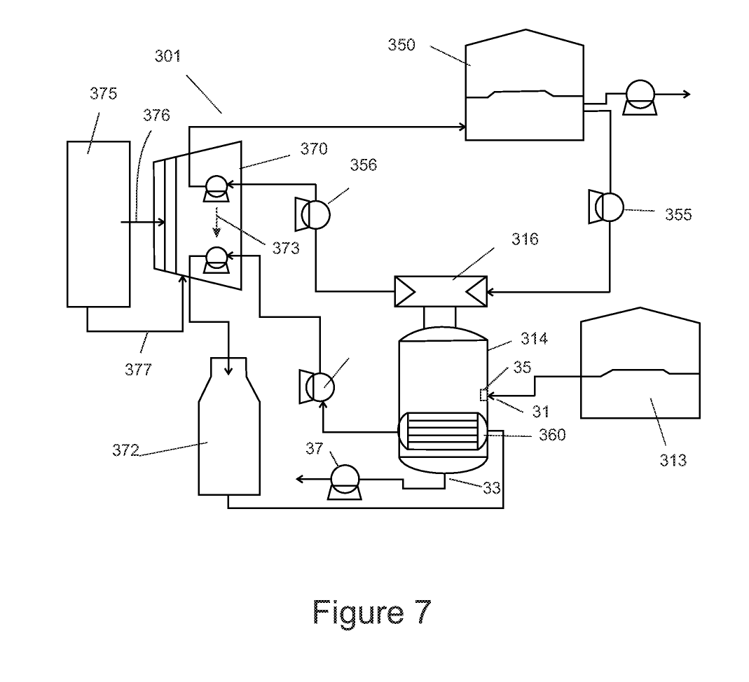

A seventh embodiment of a vapor absorption system which takes account of the energy flows associated with high production rates and high energy input is now described with reference to FIG. 7. This embodiment allows the vapor absorption system to be applied to high power, commercial operations. This embodiment is applicable to many applications but has particular application for many distillation applications. It is particularly suitable for operations where water is particularly contaminated, such as in the processing of water returned to the surface in a “fracking” operation.

Fracking is a means now used commonly for mining natural gas and oil. The seventh embodiment is generally in accordance with the fifth embodiment, but has been adapted and developed to provide distilled product on a continuous basis and achieving specific operating goals. The vapor absorption system as shown in FIG. 7 comprises an evacuation chamber 314 adapted to receive and process secondary water (produced or dirty water) received from a storage 313. The evacuation chamber 314 is provided with a heat exchanger 360 to supply latent heat of vaporization to the secondary water. The heat exchange fluid which has passed through the heat exchanger communicates with a heat pump 370, the purpose of which is discussed below.

An evacuation pump in the form of a vacuum condenser 316 is in communication with the evacuation chamber 314 and is adapted to receive water vapor from the evacuation chamber 314. The vacuum condenser 316 receives primary water under pressure from a primary water store 350 and is pressurized by pump 355, the primary water being forced through the vacuum condenser to generate reduced pressure in the evacuation chamber 314 as discussed further within the description and absorb vapor from the evacuation chamber 314 water exiting the vacuum condenser 316 comprises a primary water mixture being a mixture of the primary water and the absorbed and thereby condensed vapor from the evacuation chamber 314.

It has also been found advantageous to provide a second pump 356 in the primary water flow, the pump 356 being located on the outlet side of vacuum condenser. As has been discussed the temperature of this primary water mixture has been raised relative to the incoming primary water due to the release of latent hear when the vapor condenses. The primary water mixture is transferred to the heat pump 370 at which at least a portion of the latent heat is released to the heat exchange fluid thereby cooling the primary water mixture and returning heat energy for use in the heat exchange cycle, as is indicated by the arrow 373.

From the heat pump 370 the heat exchange fluid is passed to a heat source in the form of a water heater or boiler 372. The heat source provides additional heat energy to the heat exchange fluid to raise the temperature to that required to vaporize the secondary water. Where a suitable low grade heat source is available, this may be used instead. The cooled primary water mixture is returned to the primary water store 350. Water added to the primary water from absorption of the vapor can be drawn off from the primary water store 350 for alternative use.

As an adaptation of the embodiment, the heat pump 370 is powered by a co-generative power supply such as a microturbine 375, the direct power output of which drives the heat pump 370, as indicated by arrow 376 but as well the exhaust heat is directed to the heat pump as a heat supply for providing heat energy to the heat exchange fluid by means of suitable heat exchangers, as is indicated by arrow 377. While such a power source may need to use a high grade heat source, with effective heat recovery in place, the overall co-efficient of performance (COP) of the resulting system may make its use very attractive. In certain cases, the use of such a co-generative power supply may remove the need for a separate water heater of boiler.

With a less effective vacuum condenser the input of the desired energy to causes a higher, stable operating temperature to result when vaporizing the secondary liquid at the required rate. If a more effective vacuum condenser is used, the operating temperature will be lower. For example, in a test facility according to the seventh embodiment, a distillation rate of 100 US gallons per day was selected which required approximately 10 kW of power input with certain test vacuum condensers that were less effective, the stable operating temperature was approximately 80° C. but a superior vacuum condenser achieved an operating temperature of about 60° C. Whether the temperature of the latent heat is to be provided at 80° C. or 60° C. makes a very significant difference in how it can be provided. As indicated above, at the lower temperature it may not be necessary to provide the water heat or boiler 370, thereby reducing both capital cost and operating cost.

A further adaptation made in the seventh embodiment concerns the means of providing continuous flow of secondary water into the evacuation chamber 14 as described in relation to the first embodiment. Those skilled in the art will be aware of a number of possible means of implementing an inlet valve controlling flow of secondary liquid in to the evacuation chamber including sophisticated electrically operated and electronically or computer controlled valves.

However, for many applications, simplicity is an important factor. In a preferred adaptation of the embodiment, the first valve 33 associated with the inlet 31 comprises a float controlled valve particularly adapted for feeding fluid from a reservoir at atmospheric pressure into an evacuation chamber that is at atmospheric or sub-atmospheric pressure.

The float valve is selected to be able to utilize the sub-atmospheric conditions of the evacuation chamber to generate motive flow from the source reservoir to the evacuation chamber. This flow is substantially constant as long as the evacuation chamber remains at sub-atmospheric pressures which is the case for the system in reference. In order to cease flow, a float controlled valve has been mounted between the source reservoir and the evacuation chamber flow line, within the evacuation chamber.

The float controlled valve acts as a fluid level controller as well and upon fulfillment of the desired fluid level, the float of the float controlled valve is lifted from an open position to a dosed position. The mechanism for this lifting is due to the buoyancy of the float of the float controlled valve. Although the sub-atmospheric conditions of the evacuation chamber is capable of generating motive flow, it is unable to overcome the effects of the buoyancy of the float valve and is unable to overcome the closing pressure of the float valve given a properly sized float is utilized.

This adaptation is capable of filling and continually re-filling a chamber at atmospheric or sub-atmospheric conditions. In addition, the adaptation is able to constantly maintain a designated fluid level within the evacuation chamber. A properly selected valve may maintain a constant flow rate through it during normal operations. This adaptation for an inlet valve has the advantage of its simplicity in the application. Though widely used, float controlled valves are typically employed at atmospheric pressures and require a pressurized flow as a motive force for the flow to occur. In the present adaptation, sub-atmospheric pressures within the evacuation chamber is the source of the motive flow without disrupting the functionality of the float controlled valve to cease flow mechanically. The need for complex electronics is avoided.

A further adaptation concerns the second valve 37 associated with the outlet 35 is the employment of a positive displacement pump as the means of fluid and solids removal from the evacuation chamber. More specifically, a peristaltic pump has been employed for the removal of fluid and solids from the sub-atmospheric pressure evacuation chamber to a reservoir at atmospheric pressure.

A positive displacement of the contents desired to be removed are pumped out of the bottom of the evacuation chamber. In order to pump the fluid from the evacuation chamber to an atmospheric pressure environment, a pump that is capable of mechanically progressing fluid under sub-atmospheric conditions is required, without exposing the evacuation chamber to the atmospheric pressure of the outlet of the pump. The present invention achieves said requirements and is able to pump fluid from the bottom of the evacuation chamber from a sub-atmospheric environment to an atmospheric environment on a continual basis without exposing the evacuation chamber to atmospheric pressures.

The discharge fluid and solids from the evacuation chamber are pumped within an elastic tube fitted inside a pump casing. A rotor with a number of rollers is attached to the external circumference of the rotor. The rotor continually rotates compressing the elastic tube with the rollers in a rotary motion. As the rotor turns, the part of tube under compression is pinched closed thus forcing the fluid to be pumped to move through the tube. Additionally, as the tube opens to its natural state after the passing of the roller fluid flow is induced to the pump.

The presence of multiple rollers serves the unique purpose of always maintaining a point in the elastic tube that is in the compressed state. This effectively doses off the flow path to the outside environment minimizing the output to just fluid and solids. In addition, due to the pumping method, the pump mechanical parts never come into contact with the contents of the tube minimizing the need for exotic materials. The amount of energy required to pump fluid from the evacuation chamber is minimal compared to the high vacuum of the chamber.

It will be recognized that many modification and adaptations may be made to the embodiments described while remaining within the scope of the invention. It is to be understood that all such modifications and adaptations are to be considered as being within the scope of the inventions described.

What is claimed is:

1. A vapor absorption system comprising an evacuation chamber adapted to receive a secondary liquid and a vacuum pump operative upon the evacuation chamber to cause gas pressure within the evacuation chamber to be reduced to thereby promote the vaporization of vapor from the secondary liquid, the vacuum pump operated by a primary liquid passing through the vacuum pump, wherein the vacuum pump is configured to enable the primary liquid to receive vapor vaporized from the secondary liquid and to cause the vapor to condense within the primary liquid to provide condensed liquid mixed with the primary liquid and wherein the absorption of vapor within the system is effective to cause production of more vapor.

2. A vapor absorption system as claimed in claim 1 wherein the gas pressure is reduced to 3 kPa or lower.

3. A vapor absorption system as claimed at claim 1 wherein at least a portion of the primary liquid is circulated through the vacuum pump.

4. A vapor absorption system as claimed as claimed in claim 1 which further comprises a secondary liquid control system to control the entry of secondary liquid into the evacuation chamber.

5. A vapor absorption system as claimed as claimed in claim 4 wherein the secondary liquid control system to control entry of the secondary liquid into the evacuation chamber comprises a float valve adapted to enable the entry of the secondary liquid into by the reduced pressure within the evacuation chamber.

6. A vapor absorption system as claimed as claimed at claim 1 which further comprises a secondary liquid control system to control the exit of secondary liquid from the evacuation chamber.

7. A vapor absorption system as claimed as claimed in claim 6 wherein the secondary liquid control system to control exit of the secondary liquid from the evacuation chamber comprises a positive displacement pump adapted to pump secondary liquid from the reduced pressure environment of the evacuation chamber.

8. A vapor absorption system as claimed as claimed in claim 6 wherein positive displacement pump is a peristaltic pump.

9. A vapor absorption system as claimed as claimed in claim 1 wherein the vacuum pump is a venturi vacuum pump and the primary liquid is a liquid which passes through the venturi vacuum pump to produce a vacuum operative to evacuate the evacuation chamber and thereby receive the vapor.

10. A vapor absorption system as claimed as claimed at claim 9 wherein the venturi vacuum pump is a vacuum condenser being a venturi vacuum pump adapted to maximize the absorption of vapor from the secondary liquid into the primary liquid.

11. A vapor absorption system as claimed as claimed at claim 1 wherein a first heat exchange means is associated with the evacuation chamber to enable latent heat of vaporization to be received by the secondary liquid to support the vaporization of the secondary liquid.

12. A vapor absorption system as claimed at claim 11 wherein the first heat exchange means comprises features associated with the wall of the evacuation chamber to promote the receipt of the latent heat of vaporization £rom the surroundings.

13. A vapor absorption system as claimed at claim 11 wherein the first heat exchange means comprises a heat exchanger through which heat exchange fluid passes to surrender the latent heat of vaporisation to the secondary liquid, the latent heat of vaporisation being received by the heat exchange fluid from a source remote from the first heat exchanger.

14. A vapor absorption system as claimed at claim 11 wherein the first heat exchange means comprises a heat pump adapted to receive heat energy from a suitable source and transfer it to the secondary liquid.

15. A vapor absorption system as claimed at claim 11 wherein a second heat exchanger is provided to expel heat from the primary liquid after it has passed through the vacuum pump.

16. A vapor absorption system as claimed at claim 15 wherein the second heat exchanger reduces the temperature of the primary liquid sufficiently below the temperature of the secondary liquid to enable vapor absorption to occur at a sufficient rate when the primary liquid is recirculated to the vacuum pump.

17. A vapor absorption system as claimed at claim 15 wherein at least a portion of the heat received by the primary liquid from absorption of the vapor is directed to heat exchange means to provide some of the latent heat of vaporization required by the secondary liquid.

18. A vapor absorption system as claimed at claim 15 wherein the second heat exchanger is a heat pump.

19. A vapor absorption system as claimed at claim 1 wherein the vapor absorption system is a distillation system adapted to distil the secondary liquid wherein the condensed vapor is the same type of liquid as the primary liquid and absorption of the vapor by the primary liquid thereby increases the volume of primary liquid in the system, thereby enabling a portion of the primary liquid to be removed for use.

20. A vapor absorption system as claimed at claim 1 wherein the vapor absorption system is a distillation system adapted to distil the secondary liquid wherein the condensed vapor is a different type of liquid from the primary liquid and the distillation system comprises means to separate the condensed vapor from the primary liquid for use.

21. A vapor absorption system as claimed at claim 13 wherein the vapor absorption system is a heat exchange system wherein operation of the system causes transfer of heat by means of the first heat exchange means and the second heat exchange means.

22. A vapor absorption system as claimed at claim 19 wherein the primary liquid and the secondary liquid are of the same substance and liquid removed from the secondary liquid as vapor is replaced by an equal amount of liquid taken from the mixture of the primary liquid and condensed vapor to thereby provide a dosed system for continuous operation.

23. A distillation system comprising an evacuation chamber adapted to receive a liquid mixture to be distilled, the evacuation chamber having a space above the liquid mixture filled with a gas, and a vacuum pump associated with the evacuation chamber and adapted in use to provide a reduced pressure within the gas to cause vaporisation of the liquid mixture and wherein a primary liquid is passed in association with the gas in the evacuation chamber to receive and condense the vapor.
